(19) United States
(12) Patent Application Publication
(10) Pub. No.: US 2026/0343573 A1
(43) Pub. Date: Oct. 29, 2026

(54) A METHOD AND DEVICE FOR SIDELINK POSITIONING COORDINATION

(71) Applicant: Sony Group Corporation, Tokyo (JP)

(72) Inventors: Johan HILL, Lund (SE); Yujie ZHANG, Lund (SE); Jose FLORDELIS, Lund (SE); Basuki PRIYANTO, Lund (SE); Anders BERGGREN, Lund (SE)

(21) Appl. No.: 19/111,625

(22) PCT Filed: Sep. 22, 2023
(86) PCT No.: PCT/EP2023/076233

§ 371 Date: Mar. 13, 2025

(30) Foreign Application Priority Data
Sep. 30, 2022 (SE) 2251125-7

(51) Int. Cl. H04W 72/40; H04W 4/02; H04W 72/25; H04W 92/18

(52) U.S. Cl. CPC H04W 72/40; H04W 4/023; H04W 72/25; H04W 92/18

(57) ABSTRACT

A method is disclosed, performed by a primary wireless device. The method comprising. determining a location reference signal configuration for sidelink positioning to be used by a plurality of secondary wireless devices. The method comprising transmitting, to the plurality of secondary wireless devices, an indication indicative of the location reference signal configuration.

The present disclosure pertains to the field of wireless communications. The present disclosure relates to methods for coordinating configuration of resources for sidelink positioning reference signal transmission, and a related wireless device.

### BACKGROUND

Sidelink communication has been used as part of the 3^{rd} Generation Partnership Project (3GPP) New Radio (NR) Vehicle to Everything (V2X). In NR V2X context, a radio network node, such as a gNB, may communicate directly to the wireless device (WD) using a Uu interface and the WD(s) may also communicate directly with each other using a PC5 interface. The WD in V2X may be a Road Side Unit (RSU), a vehicle, such as a car, comprising a communication module, a Vulnerable Road User (VRU), such as a WD associated with a pedestrian and/or cyclist, etc. The WDs may communicate with each other via a sidelink, such as using a PC5 interface, without communicating via the radio network node.

Radio resources used for sidelink communications (such as for communication between WDs) are within a resource pool, such as a set of resources, to be used for sidelink communication. Transmissions of a reference signal, control channel, and data channel from one or more WDs are all within a given resource pool. For positioning purpose, a large number of frequency resources are needed, particularly for accurate positioning measurement.

In V2X positioning, it can be advantageous to perform simultaneous sidelink positioning (SL-Pos) of multiple WDs involving cars, vulnerable road users (VRU), and RSUs. Furthermore, potential WD collisions can be avoided if the positioning operation is performed with a short latency. Simultaneous SL-Pos involves multiple WDs transmitting sidelink positioning reference signal (SL-PRS).

### SUMMARY

Accordingly, there is a need to enhance the legacy V2X for devices and methods, particularly for sidelink positioning coordination, which may mitigate, alleviate or address the shortcomings existing and may provide improved sidelink resource scheduling and allocation while reducing latency in the network.

A method is disclosed, performed by a primary wireless device. The method comprises determining a location reference signal configuration for sidelink positioning to be used by a plurality of secondary wireless devices. The method comprises transmitting, to the plurality of secondary wireless devices, an indication indicative of the location reference signal configuration.

Further, a primary wireless device is disclosed, comprising memory circuitry, processor circuitry, and a wireless interface. The primary wireless device is configured to perform any of the methods disclosed herein.

It is an advantage of the present disclosure that latency can be reduced. As the method, performed by the first wireless device, can coordinate location reference signal configurations with a plurality of second wireless devices, instead of “one-to-one” communication of legacy devices, signaling can be performed more efficiently, such as by reducing latency, reducing the probability of packet collisions and/or reducing interference caused by wireless devices having a resource configuration unknown to a wireless device performing a positioning procedure, herein also referred to as “hidden devices”. Further, advantageously the disclosed method can reduce and/or avoid errors caused by moving wireless devices, such as for absolute position determination. Additionally, in certain implementations, WDs can save resources and/or energy because only the resource scheduling WD is required to sense a positioning resource pool of the network, for example leading to low signaling overhead. Moreover, the disclosed method allows for more WDs to be involved with positioning, which can provide better positioning accuracy.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example first wireless device and an example plurality of second wireless devices according to this disclosure,

FIG. 2 is a signaling diagram illustrating an example message exchange for example sidelink positioning coordination according to this disclosure,

FIG. 3 is a signaling diagram illustrating an example message exchange for example sidelink positioning coordination according to this disclosure,

FIG. 4 is a signaling diagram illustrating an example message exchange for example sidelink positioning coordination according to this disclosure,

FIG. 5 is a flow-chart illustrating an example method, performed by a first wireless device, for a sidelink positioning coordination according to this disclosure, and

FIG. 6 is a block diagram illustrating an example wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

Disclosed herein are methods for resource allocation and positioning operation coordination mechanisms where a first wireless device (WD) can be assigned as a resource allocator, or coordinator, for the transmission and/or reception of location reference signals (LRS) and/or LRS configurations, such as SL-PRS and/or SL-SRS, from a plurality of surrounding second wireless devices. The second WDs can transmit LRSs simultaneously or at least in a same time window, thereby reducing packet collision and improving latency. A wireless device may refer to a mobile device and/or a user equipment, UE.

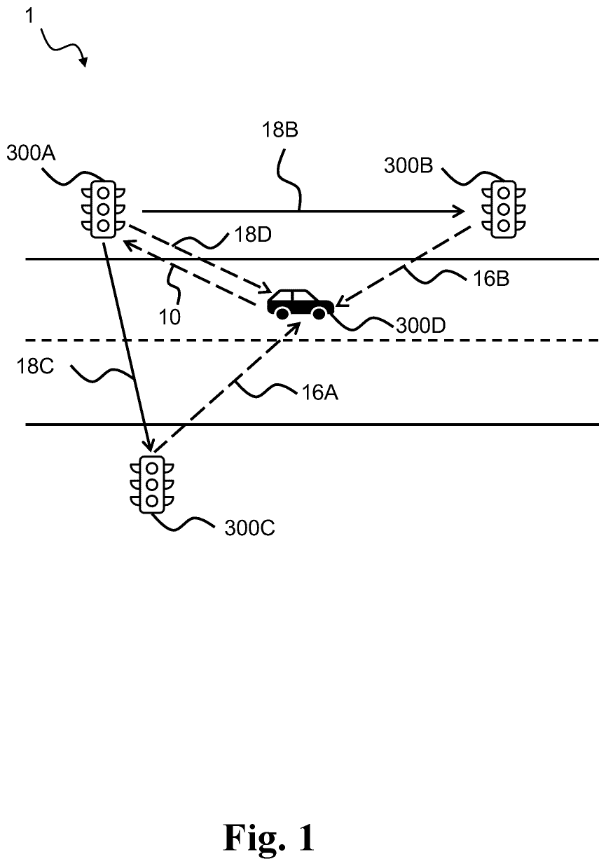

The following is one example as disclosed herein. A primary WD can provide an indication of a LRS configuration to a plurality of secondary WD(s) to transmit LRSs, such as positioning reference signals (PRSs) within a given resource pool. The primary WD can define the location reference signal configuration by sensing a channel in a given time/frequency (such as in a sensing window). An example primary WD is shown in FIG. 1 as first WD 300A. The primary WD can be triggered by other WD(s) (including the plurality of secondary WDs and/or a tertiary WD), such as by receiving a positioning resource configuration assistance request, to define the resource allocation for LRS transmission. The tertiary WD may be a target WD to be positioned. The indication may include generic parameters (such as a LRS resource allocation structure, a size of a sidelink resource pool, such as a resource allocation size) and/or specific parameters (such as, time/frequency offset, an activation indicator, such as an indicator indicating an on/off switching of resources, an identifier associated with the one or more of the plurality of secondary wireless devices, such as of a LRS source WD and/or a LRS destination WD). The LRS source WD may be a WD transmitting an LRS and the LRS destination WD may be a WD receiving a LRS. The LRS for the plurality of secondary WDs can be time and/or frequency domain multiplexed within a given resource pool. The plurality of secondary WDs can identify their own resources for LRS transmission indicated explicitly by the primary WD. In some examples, the plurality of secondary WDs can identify its own resources by using certain functions and/or formulas, for example derived from the respective identifier associated with the one or more of the plurality of secondary wireless devices. In one or more example methods, the primary WD triggers the tertiary WD to perform positioning measurement based on the LRS received from the plurality of secondary WDs. A trigger may be sent to the tertiary WD in the location reference signal configuration described above or in a separate message.

In one or more examples, the disclosed wireless systems and methods can use resource pools for resource allocation of SL-LRS. The concept of a resource pool is applied in autonomous resource allocation of WDs where resources are selected based on a sensing procedure on a specific resource pool. In the frequency domain, a resource pool is divided into sub-channels which are consecutive and non-overlapping physical resource blocks (PRBs). The size of a resource pool is configured by higher layers through signaling by a radio network node, such as a gNB (such as in case of mode 1), and the transmission and reception resource pools are configured separately. In one or more examples, an extra resource pool is configured for each WD for exceptional cases, such as for radio link failure (RLF) or handover, where the WD has no stable configuration of the transmission resource pool, but V2X communication is required. The extra resource pool may only be provided for temporary usage.

3GPP Rel-16 specifies two resource allocation modes for NR sidelink communication: modes 1 and 2. In mode 1, a radio network node, such as the gNB, allocates the resources for in-coverage WDs, such as WDs being in coverage of the radio network node. In mode 2, WDs autonomously select resources based on a sensing procedure. WDs can reserve resources, such as for blind re-transmissions and Hybrid automatic repeat request (HARQ) feedback-based re-transmissions, that other WDs with higher priority traffic may not use. The information about the reservation can be transmitted in a sidelink control information (SCI). A WD can perform sensing for example at least between 1100 ms and 100 ms before the reservation time, which may add some latency to a scheduling procedure.

Furthermore, 3GPP Rel-17 specifies inter-UE coordination (IUC) for SL mode 2 with the purpose to alleviate the problem of collisions caused by hidden nodes, such as nodes not aware of each other's resource allocations. In IUC, an assistant UE may provide suggestions to other UEs (such as assisted UEs) to inform their resource selection. Inter-UE coordination can also be inter-WD coordination. There are two operation modes: Type A and Type B. In Type A operation mode, the assistant UE (UE1) restricts the resources that can be used by the assisted UE(s). In Type B, the assistant UE recommends resources to the assisted UEs(s), which can decide whether or not to follow the recommendations from the assistant UE. Current IUC generally has each UE sensing its own allocation. Further IUC description is specified in TS 38.300 v17.1.0 (chapter 16.9.8), TS 38.321 v17.1.0 (chapter 5.22.1.9, 5.22.1.10, 6.1.3.53, 6.1.3.54) and TS 38.214 v17.2.0 (chapter 8.1.4A). Further description of SCI is specified in TS 38.212 v17.2.0.

As an example, a particular coverage area may include three WDs, such as a WD A, a WD B, and a WD C. WD B is located between WD A and WD C and is within communication range of both WD A and WD C. However, WD A and WD C are outside of communication range with each other. Accordingly, WD B is within WD A and WD C range and can detect reservations (such as resource reservations) from both WD A and WD B. However, this is not the case between WD A and WD C, which can end up selecting the same resources for their transmissions. In one example, WD B has reserved a sub-channel SC2 at a slot S2. WD C has reserved a sub-channel SC1 at a slot S2 and a sub-channel SC2 at a slot S4. The resource reservation of WD B is detected by WD A and by WD C. However, reservations of WD C are only detected by WD B and not by WD A: WD C is thus hidden from WD A. Now, WD A generates a Transport Block (TB) in slot S1. Without IUC, WD A would detect slots S2 to S5 of sub-channel SC1 as available, with the subsequent risk of collisions with WD C transmissions. However, the IUC disclosed herein can mitigate the hidden terminal problem: WD B may assist WD A with recommendations (type B) for WD A's resource selection. As a result, the resource selection of WD A can consider the reservations of WD C, thereby reducing the probability of packet collisions.

Expressed in a generic manner, SL positioning requires multiple LRS transmitters for the measuring (receiving) WD to perform time difference of arrival (TDOA) measurements or for all WDs to perform multi-round-trip-time (RTT) measurements. In an example of a vehicle driving down a road, it may be advantageous to obtain a position fix for the vehicle. For SL-TDOA-based positioning, three nearby WDs, such as RSUs, transmit SL-LRSs toward the vehicle to be positioned, within a given time window. The vehicle receives the SL-LRSs, measures the timing delays, and calculates the corresponding time differences of arrival (TDOAs). The TDOAs may be used further for vehicle fix estimation. In SL-multi-RTT-based positioning, SL-LRSs are transmitted in both directions: forward SL-LRSs from the SL-LRS transmitting WDs, such as the RSUs, to the vehicle and backward SL-LRSs from the vehicle to the RSUs. One issue with these techniques is that the vehicle movement may cause errors in the TDOA and Multi-RTT measurements, which degrades the positioning accuracy.

The figures are schematic and simplified for clarity, and they merely show details which aid understanding the disclosure, while other details have been left out. Throughout, the same reference numerals are used for identical or corresponding parts.

FIG. 1 is a diagram illustrating an example wireless communication system 1 comprising an example first wireless device 300A, an example plurality of second wireless devices 300B, 300C, and an example third wireless device 300D according to this disclosure. As discussed in detail herein, the present disclosure relates to a wireless communication system 1 comprising a cellular system, for example, a 3GPP wireless communication system. The wireless devices 300A, 300B, 300C, 300D may be configured to communicate directly with each other via a sidelink (illustrated as transmissions 16A, 16B, indications 18B, 18C, 18D and request 10), such as via a PC5 interface. For example, the sidelink is a wireless link. The communication between the WDs 300A, 300B, 300C, 300D uses radio resources, such as from a resource pool. The third WD 300D can be a moving WD, such as a vehicle shown in FIG. 1. However, the third WD 300D may be stationary as well. The first WD 300A and the second WDs 300B, 300C may be stationary WDs, such as RSUs, or may be non-stationary WDs (not shown in FIG. 1).

One or more of the wireless devices 300A, 300B, 300C, 300D may be a WD configured to transmit sidelink LRS, such as SL-PRS or SL-SRS, via the PC5 interface. One or more of the wireless devices 300A, 300B, 300C, 300D may be configured to receive the sidelink LRS and may perform positioning measurements on the LRS received. The WD that is to be positioned can herein be referred to as a target WD. The target WD may be either a WD transmitting LRS and/or a WD receiving LRS depending on the positioning measurement that is performed. In order to perform LRS transmission, the WDs 300B, 300C, 300D may require an LRS configuration, so that the WDs 300B, 300C, 300D, such as the LRS transmitting WDs and/or the LRS receiving WDs, are aware of the time and/or frequency location and parameters of the LRS.

As will be discussed in further detail below, the third WD 300D can be configured to transmit, to the first WD 300A, a positioning resource configuration assistance request 10 (such as a resource configuration request). Accordingly, the third wireless device 300D can be known as a sidelink positioning initiating WD. The first wireless device 300A is configured to receive, from the third wireless device 300D, the positioning resource configuration assistance request 10. The first WD 300A can act as a resource scheduling WD to determine a location reference signal configuration for sidelink positioning to be used by the plurality of second wireless devices 300B, 300C. For example, the first wireless device 300A can be configured for sensing, such as sensing the sidelink resource pool of the wireless network, and scheduling resources, such as for LRS transmission, such as PRS and/or Sounding Reference Signals (SRS) transmission.

The first WD 300A can transmit, to the plurality of second wireless devices 300B, 300C, and optionally to the third wireless device 300D, an indication 18B, 18C, 18D, indicative of the LRS configuration. Accordingly, the plurality of second WDs 300B, 300C can act as assisting WDs, for transmitting LRS signals 16A, 16B according to the respective LRS resources. In certain implementations, the first WD 300A can be configured to transmit, to the third WD 300D, the indication 18D. Second WDs 300B, 300C can be configured to receive the indication 18B, 18C, respectively. In one or more example methods, one or more of the plurality of second WDs can identify the resource explicitly from the indication. In one or more example methods, one or more of the plurality of second WDs 300B, 300C can derive the resource allocation for LRS based on a certain formula, such as the number of resources and/or a function of the one or more WD identifier (ID).

In other words, the third WD 300D sends a request to the first WD 300A for resource scheduling assistance via request 10. The first WD 300A may schedule and/or allocate LRS resources by performing discovery of potential assistant WDs (such as of the plurality of second WDs 300B, 300C) for transmission and/or reception of LRS. The first WD 300A may then sense and reserve resources for each LRS transmission (such as from one of the plurality of second WDs 300B, 300C to the third WD 300D and from another WD of the plurality of second WDs 300B, 300C to the third WD 300D). The first WD 300A may be configured to groupcast the resource allocation (such as the scheduled LRS resources) configuration to all the other entities, for example to one or more of the plurality of second WDs 300B, 300C and/or to the third WD 300D. One or more of the first WD 300A, the plurality of second WDs 300B, 300C (such as transmitters) and the third WD 300D (such as receiver) performs, for example, a positioning procedure, such as LRS transmission and/or reception according to the allocation request. In one or more example methods, both the LRS transmitter WD and LRS receiver WD are not the initiating WD (such as third WD 300D). For example, first WD 300A is configured to configure one of the plurality of second WDs 300B to transmit an LRS transmission and another of the plurality of second WDS 300C to receive (such as LRS reception).

In one or more example methods, the sensing and/or selection of resources can, for example, be applicable for data payload but also for a reference signal transmission request, such as a request for LRS, such as PRS and/or for SRS, for sidelink communication purpose. It may be advantageous to simultaneously and/or closely schedule LRS transmissions from different LRS source WDs (such as from different LRS transmitting (Tx) WDs). For example, a resource scheduling WD (such as the first WD 300A in FIG. 1) can this way select the resources to be used by the plurality of second WDs, such as the LRS transmitting source WDs 300B, 300C in FIG. 1. The resource selection may indicate a LRS resource allocation structure, such as a comb-structure, an offset in the comb-structure (such as used for shifting the resource elements so as to not use the same resource elements for every scheduling, such as to ensure that simultaneous transmitting WDs use, for example, a different offset for performing LRS transmission), and a frequency and time allocation of the LRS resources.

In one or more example methods, the communications discussed above can be sidelink communications. Sidelink communication may be used as part of NR-V2X. The WDs 300A, 300B, 300C in V2X can be stationary WDs, such as a Road Side Unit (RSU), or non-stationary WDs 300D, such as vehicles having a communication module, or a Vulnerable Road User (VRU), such as a WD carried by a pedestrian and/or a cyclist.

In SL positioning, multiple WDs can be within an area where they can communicate with each other. Some WDs are expected to transmit SL-LRSs, and some other WDs are expected to receive the SL-LRSs. In legacy SL-IUC, coordination is performed “one-to-one,” meaning one WD can only perform configuration (resource sensing, selection, and reservation) with one other WD at a given time. However, these “one-to-one” interactions with many surroundings WDs could increase the communication latency and the number of resources required for signaling.

In one or more example methods, the method advantageously can alleviate the aforementioned problems (such as high latency and inefficient signaling) in supporting SL-positioning for multiple WDs. For example, the disclosed methods can be configured to improve scheduling/allocation of resources for SL-based positioning where the WDs allocate and arrange the resources by itself by introducing a centralized unit (such as a resource scheduling WD, such as the first WD 300A in the example shown in FIG. 1) to configure resources for other WDs performing a sidelink positioning procedure (such as for one or more LRS source WDs, such as the plurality of second WDs 300B, 300C in the example shown in FIG. 1, and/or one or more LRS destination WDs, such as the third WD 300D in the example shown in FIG. 1), aiming to reduce the latency due to the unnecessary sensing and resource selection. Further, in one or more example methods, transmission and reception can be within the same time window so that multiple positioning measurement results from multiple WDs can be used together, such as for absolute position, collision avoidance, and so on. Advantageously, the disclosed methods and systems allow for resource coordination between multiple WDs, such as WDs participating in a sidelink positioning procedure.

A resource pool concept has been defined for legacy sidelink communication (such as for Long Term Evolution (LTE) V2X, and/or NR V2X). A resource pool can be seen as a set of resources to be used for sidelink communications, such as between WDs 300A, 300B, 300C, 300D. The resource set (such as the resource pool) consists of (time) slots and Resource Blocks (RB) to be used by several WDs for their sidelink transmissions. Sidelink communication is mainly carried by a Physical Sidelink Control Channel (PSCCH) and a Physical Sidelink Shared Channel (PSSCH). A resource pool may be divided into sub-channels in the frequency domain, which are consecutively non-overlapping sets of Physical Resource Blocks (PRBs) (such as ≥10 PRBs) in a slot. The size of the resource pools may be dependent on (pre-) configuration settings. The resource allocation, carrier-sensing, and resource selection may be performed in units of a sub-channel.

For sidelink communication between a transmitting (Tx) WD and a receiving (Rx) WD, each transport block, such as each packet of data, that is passed between the Tx WD and the Rx WD has an associated sidelink control information (SCI) message. The SCI may be divided into two different stages, a first stage SCI carried by PSCCH and a second stage SCI carried by PSSCH. The two SCI stages may support different functionalities.

The first stage SCI mainly comprises resource allocation information, while the second stage SCI comprises link-specific information, such as information related to the sidelink between the Tx WD and the Rx WD.

Positioning of the target WD can be performed in a plurality of ways. According to a first example method according to this disclosure, the target WD may perform measurements of LRS transmitted by a Tx WD, such as an RSU, a car, etc. According to a second example method, the target WD (such as a VRU or a vehicle) may transmit LRS for a supporting WD, such as a car and/or a pedestrian, to measure on.

The current disclosure thus provides methods for allocating resources for transmission of SL-LRS in a WD autonomous operation (such as in sidelink mode 2).

In one or more example methods, a WD (such as second WDs 300B, 300C) may be provided with an indication indicative of a configuration, such as a location reference signal configuration for sidelink positioning (such as a dedicated sidelink positioning resource configuration). For example, the WD may be provided with the indication through the use of a radio resource control (RRC) SL message. The indication indicative of the location reference signal configuration may comprise properties and/or parameters of resources for SL-LRS (such as of a resource pool configuration for SL-LRS monitoring). The indication can be indicative of SL-LRSs that should be monitored. The indication indicative of the location reference signal configuration for sidelink positioning may be conveyed, such as provided, to the WD via Sidelink Control information (SCI).

In one or more example methods, the indication indicative of the location reference signal configuration for sidelink positioning may be transmitted by a resource scheduling WD (such as the first WD 300A in FIG. 1), such as a resource scheduling WD, to the WDs performing a sidelink positioning procedure (such as to the Tx WD configured to transmit LRS, such as the plurality of second WDs 300B, 300C, and the Rx WD configured to measure on received LRS, such as WD 300D). The indication indicative of the location reference signal configuration for sidelink positioning may be groupcasted to two or more of the WDs. Groupcasting may be seen as transmitting (such as broadcasting, sending) of the indication to a particular group of WDs. In one or more example methods, groupcasting can be seen as transmitting the indication at the same time (or roughly the same time) to the particular group of WDs.

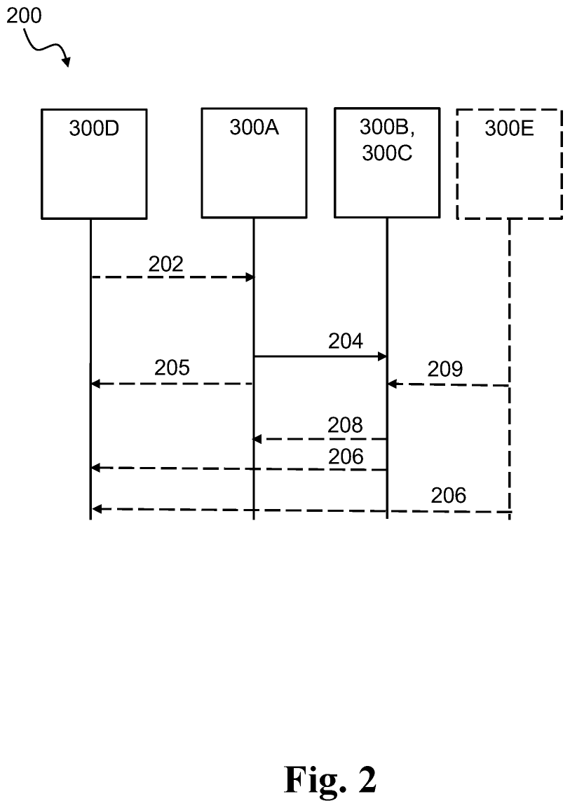

FIG. 2 is a signaling diagram illustrating an example message exchange 200 for sidelink positioning coordination according to this disclosure. Reference is made to the devices and signaling of FIG. 1 for convenience, but is not so limited.

As shown, a third WD 300D wants to have localization (such as having its position determined) and requires assistance. Accordingly, the third WD 300D transmits a positioning resource configuration assistance request 202. In one or more example methods, the positioning resource configuration assistance request 202 may comprise a request for sensing and a request for LRS transmissions, such as PRS transmission. The third WD 300D may be an Rx WD (such as a LRS destination WD) being configured to receive LRSs during a sidelink positioning procedure and or a Tx WD being configured to transmit LRSs during a sidelink positioning procedure. In the context of the example message exchange 200, the third WD 300D is a positioning initiating WD being configured to transmit, to the first WD 300A, the positioning resource configuration assistance request for performing positioning measuring. The plurality of second WDs 300B, 300C may be TX WDs being configured to transmit LRSs during a sidelink positioning procedure.

The first WD 300A receives the positioning resource configuration assistance request 202 and determines a location reference signal configuration for sidelink positioning to be used by a plurality of second wireless devices 300B, 300C. For example, the first WD 300A senses the sidelink resource pool and selects resources for sidelink positioning. The first WD 300A transmits, to the plurality of second wireless devices 300B, 300C, an indication 204 indicative of the location reference signal configuration, such as a resource configuration for transmitting LRS in sidelink. This corresponds to the signaling 18B, 18C in FIG. 1. The first WD 300A may, in one or more example methods, transmit, to the third WD 300D, the indication 205 indicative of the location reference signal configuration, such as a resource configuration for receiving LRS in sidelink.

The plurality of second WDs 300B, 300C transmit LRSs 206, such as SL-PRS, to the third WD 300D based on the received indication 204. In some example methods, the plurality of second WDs 300B, 300C transmit LRSs 208 also to the first WD 300A.

FIG. 2 also illustrates an LRS transmission between two of the plurality of second WDs (such as from another second WD 300E to one of 300B, 300C). 300B, 300C, and 300E are all acting as assisting WDs. For example, additional second WD 300E can transmit LRSs 206 to the third WD 300D. Further, additional second WD 300E can transmit LRs 209 to one or more of the plurality of second WDs 300B, 300C.

In the example of FIG. 2, the third WD 300D requests both sensing and LRS transmission and acts as a positioning initiating WD. The first WD 300A acts as a resource scheduling WD for scheduling resources for LRS. The plurality of second WDs 300B, 300C act as Tx WDs (such as LRS source WDs). In the example of FIG. 2, the first WD 300A and the third WD 300D act as Rx WDs (such as LRS destination WDs).

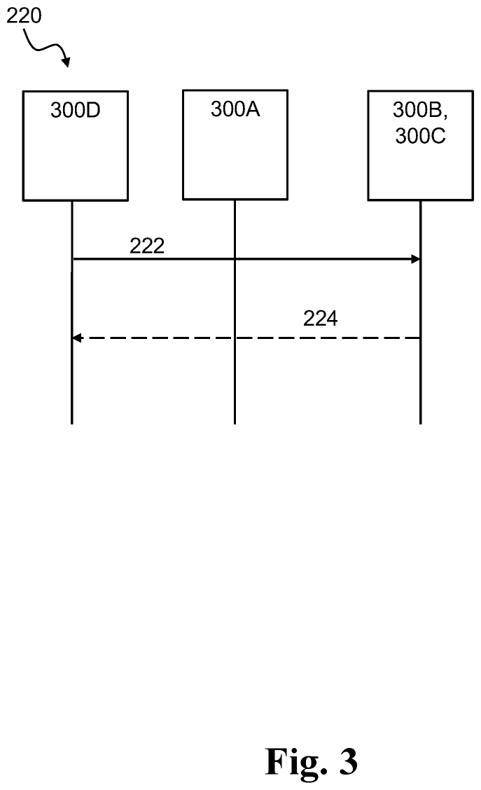

FIG. 3 is a signaling diagram illustrating an example message exchange 220 for an example sidelink positioning coordination according to this disclosure. In the example shown in FIG. 3, the third WD 300D, such as the WD to be positioned, initiates itself as a resource scheduling WD. As shown, first WD 300A is not actively being used in this situation. In other words, the third WD 300D acts as the resource scheduling WD and the positioning initiating WD. As shown, the third WD 300D determines a location reference signal configuration for sidelink positioning to be used by the plurality of second wireless devices 300B, 300C. Accordingly, the third WD 300D does not need to receive a positioning resource configuration assistance request prior to determining the LRS resource configuration. For example, the third WD 300D can be configured to sense and select resources for the LRS transmission. For example, the third WD 300D transmits, to the plurality of second wireless devices 300B, 300C, an indication 222 indicative of the location reference signal configuration. The indication 222 may comprise an allocation request of reference signal transmissions, requesting a set of physical resources to be used for LRS transmissions. The plurality of second WDs 300B, 300C may, based on the indication 222, determine the LRS resources. The plurality of second WDs 300B, 300C transmit (such as respond) LRSs 224 to the third WD 300D using the resources allocated and/or reserved by the third WD 300D in the indicated location reference signal configuration.

In this example, the third WD 300D, such as the WD to be positioned, initiates sensing of the sidelink resource pool and requests LRS transmission based on the sensed resources. Accordingly, the third WD 300D acts as a positioning initiating WD and a LRS resource scheduling WD. The plurality of second WDs 300B, 300C act as Tx WDs (such as LRS source WDs). The third WD 300D acts as Rx WD (such as a LRS destination WD).

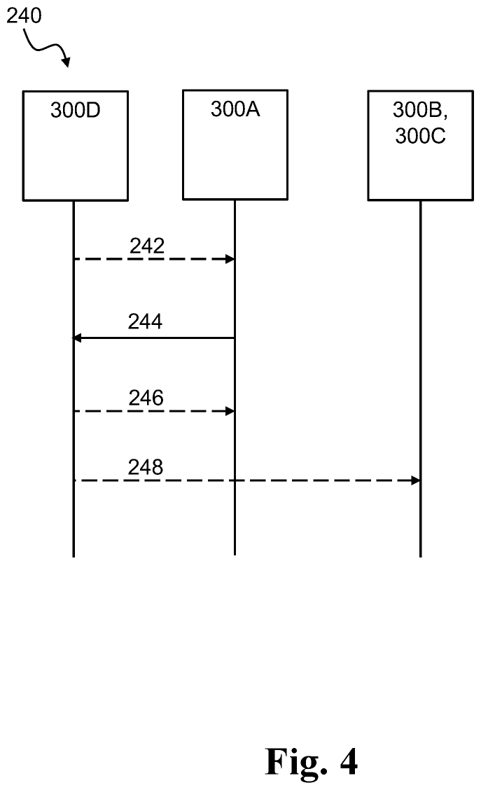

FIG. 4 is a signaling diagram illustrating an example message exchange 240 for sidelink positioning coordination according to this disclosure.

As shown, the third WD 300D needs localization (such as requires positioning measuring) and requires assistance. Accordingly, the third WD 300D transmits, to the first WD 300A, a positioning resource configuration assistance request 242. The third WD 300D may thus act as a positioning initiating WD). The first WD 300A receives the request 242 and determines a location reference signal configuration for sidelink positioning to be used by a plurality of second wireless devices 300B, 300C. For example, the first WD 300A may determine the location reference signal configuration by sensing and selecting resources for positioning. The first WD 300A transmits, to third WD 300D, an indication 244 indicative of the location reference signal configuration. The third WD 300D transmits LRS 246 (such as performs a LRS transmission) to the first WD 300A. The third WD 300D may transmit LRSs 248 to the plurality of second WDs 300B, 300C.

In the example of FIG. 4, the third WD 300D requests both sensing and LRS transmission and acts as a positioning initiating WD. The first WD 300A determines the location reference signal configuration for sidelink and thus acts as a resource scheduling WD. The third WD 300D acts as a Tx WD (such as a LRS source WD). The first WD 300A and the plurality of second WDs 300B, 300C act as Rx WD (such as LRS destination WDs).

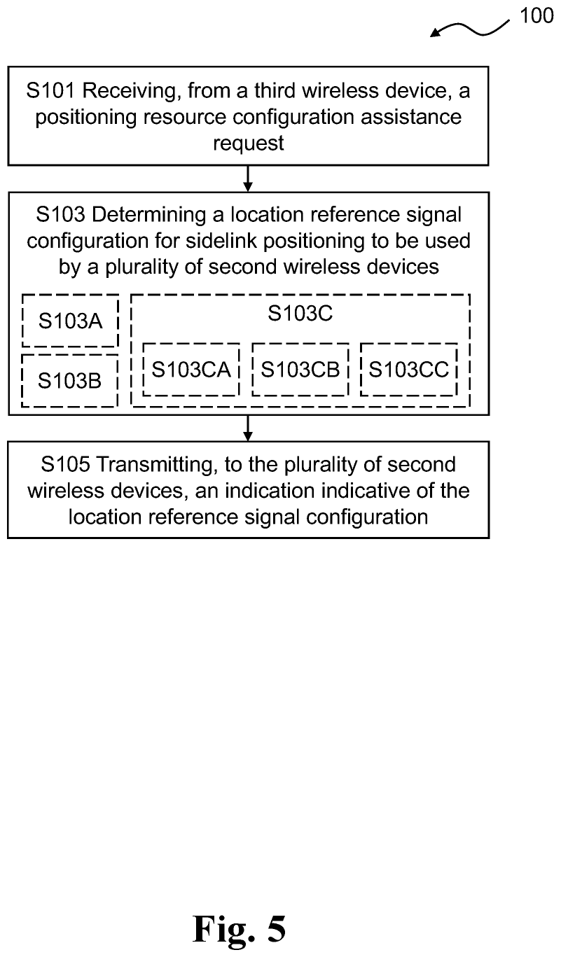

FIG. 5 shows a flow chart of an example method 100, performed by a primary wireless device according to the disclosure (such as a resource scheduling wireless device), for sidelink positioning coordination. The primary wireless device may be considered a resource scheduling wireless device such as disclosed with respect to FIGS. 1-4.

In one or more example methods, the method 100 includes receiving S101, from a tertiary wireless device, a positioning resource configuration assistance request. The tertiary WD can be a WD to be positioned. The positioning resource configuration assistance request can be seen as an indication from the tertiary WD to the scheduling WD that the tertiary WD needs to have its positioning determined (such as localization) through the use of assistance for measurements. The tertiary WD may, in one or more example methods, be an initiating WD, such as a sidelink positioning initiating WD. In one or more example methods, the positioning resource configuration assistance request includes one or more of: a first assistance indication indicating that the positioning resource configuration assistance request is for location reference signal transmission, a respective first identifier associated with one or more of the plurality of second wireless devices, a second assistance indication indicating a number of second wireless devices, and a measurement indication indicating the expected positioning measurement-type.

The method 100 comprises determining S103 a location reference signal configuration for sidelink positioning to be used by a plurality of secondary wireless devices (such as the plurality of second wireless devices 300B, 300C of FIG. 1 to 4, and/or the third wireless device 300D of FIG. 1 to 4). In one or more example methods, determining S103 comprises reserving resources for LRS transmission. The location reference signal configuration can be seen as a configuration of resources, such as time and/or frequency resources, which can be used for performing a positioning procedure in sidelink. In one or more example methods, the LRS can be a SL-PRS and/or an SRS. In one or more example methods, the LRS configuration can be a common resource configuration, such as valid for one or more WDs (such as Tx LRS WDs). In one or more example methods, the LRS configuration is a common resource configuration which is the same for the one or more WDs. The one or more WDs may have individual aspects of the common resource configuration, such as based on their respective WD ID. In one or more example methods, determining S103 is done in response to receiving the positioning resource configuration assistance request. In other words, receiving the positioning resource configuration assistance request may trigger the determining S103.

In one or more example methods, determining S103 the LRS configuration includes sensing S103A on a sidelink resource pool. In some examples, determining S103 comprises performing a clear channel assessment in order to determine the LRS configuration. In some examples, determining S103 comprises performing a channel access procedure, which includes the primary WD sensing the channel and then performing a channel occupancy procedure. In one or more example methods, the resources for sensing and the reserved allocation may be close to each other in the time domain in order to mitigate the effect from WD movement. In one or more example methods, the resources may be assigned in the same time slot/symbols, such as using a same comb size but with different resource element shift. In one or more example methods, sensing the sidelink resource pool comprises sensing energy levels over time. In one or more example methods, the energy levels can be compared to a criterion. In accordance with the energy levels meeting the criterion, the given resource can be determined to be available. In accordance with the energy levels not meeting the criterion, the given resource can be determined not to be available. The particular type of sensing is not limiting, and any used sensing methodology can be applied for determining available resources.

In one or more example methods, determining S103 includes determining S103B the location reference signal configuration for sidelink positioning based on the sensing. For example, when a transmitting (Tx) WD transmits a LRS, the receiving (Rx) WD should receive that LRS. Accordingly, the sensing may be used for determining, such as for making a decision on, the particular location reference signal configuration to be sent via indication to the plurality of secondary WDs, by the primary WD.

In one or more example methods, determining S103 includes allocating S103C respective location reference signal resources for a plurality of location reference signal transmitting wireless devices of the plurality of second wireless devices. In some examples, the location reference signal resources are grouped in time. In other words, the LRS resources can be allocated closer together in time. The allocation may arrange resources, such as SL-LRS resources, to be used for the positioning procedure over the sidelink with respect to the plurality of secondary WDs, such as within a dedicated sidelink positioning resource configuration.

In one or more example methods, allocating S103C the respective location reference signal resources includes allocating S103CA) respective location reference signal resources in a first time slot. In one or more example methods, allocating S103C the respective location reference signal resources includes allocating respective location reference signal resources in a first predetermined time. This can allow for transmissions to occur closely together, which can be advantageous for communication with a moving WD. In one or more example methods, allocating S103C the respective location reference signal resources includes allocating S103CB respective location reference signal resources in a first symbol. This can allow for transmissions to occur closely together, which can be advantageous for communication with a moving WD. In one or more example methods, allocating S103A the respective location reference signal resources includes allocating S103CC respective location reference signal resources in adjacent symbols. Accordingly, the allocating S103A may be simultaneous in some example methods, nearly simultaneous in other example methods, and closely transmitted in even other example methods.

The method 100 comprises transmitting S105, to the plurality of secondary wireless devices, an indication (such as indication 108B, 108C, 108D of FIG. 1) indicative of the location reference signal configuration. For example, the indication can be transmitted as an RRC SL message from the primary WD to the plurality of secondary WDs. In one or more example methods, the indication can be transmitted as an SCI sidelink message from the primary WD to the plurality of secondary WDs. In one or more example methods, the indication can be one or more of PSSCH, PC5-RRC, SCI-1, SCI-2 and PC5-MAC (such as sidelink configured grant confirmation MAC control element (CE)). In one or more example methods, the method 100 comprises transmitting, to the plurality of secondary wireless devices, one or more indications indicative of the location reference signal configuration. In one or more example methods, the method 100 includes transmitting, to at least one of the plurality of secondary wireless devices, an indication indicative of the location reference signal configuration. In one or more example methods, the first wireless device is a resource scheduling wireless device. In one or more example methods, the method 100 is for sidelink positioning of a particular WD, such as of a tertiary WD (such as third WD 300D of FIG. 1). Transmitting S105 may comprise transmitting the indication using groupcast to the plurality of secondary wireless devices, or using unicast to each of the plurality of secondary wireless devices individually. In one or more example methods, the primary WD transmits the same indication to each of the plurality of secondary WDs. For example, the method 100 can include transmitting, by the primary WD, the indication as a groupcast to the plurality of secondary WDs. Groupcast can herein be seen as a WD (such as first WD 300A) groupcasting the indication to a specific set of WDs belonging to a group of WDs (such as the plurality of second WDs 300B, 300C). A group of WDs may have its dedicated group ID, which may be referred to as ProSe Layer-2 Group ID which is used in a data transmission when the WD sends the indication to the group of WDs. Currently the management of the WD belonging to a group is handled in the application layer, while the configuration of the group is handled in a Radio Resource Control (RRC) layer. Handled in the application layer can herein be seen as the management of the WDs belonging to the group being performed in an application function and being signaled from the application layer. Groupcast can herein be seen as communication between all WDs belonging to a group, such as to a sidelink group. In one or more example methods, transmitting S105 comprises transmitting the indication as a groupcast to one or more groups of the plurality of secondary WDs. In one or more example methods, the primary WD transmits different indications to the respective WDs of the plurality of secondary WDs, for example having resources allocated in the same time slot and/or symbols. Different indications can include the same content and/or information, but distinct and/or dedicated signaling. In one or more example methods, transmitting S105 comprises transmitting, by the primary WD, the indication as a plurality of indicative unicasts to each of the plurality of secondary WDs.

In one or more example methods, the respective location reference signal resources for the plurality of location reference signal transmitting wireless devices have different resource element offsets. Resource element offsets can also be known as resource element shifts. For example, the resource element offsets may be frequency offsets and/or time offsets. For example, the LRS configuration can be indicative of the frequency offsets and/or time offsets. For example, the indication can be indicative of the frequency offsets and/or time offsets.

In one or more example methods, the indication is indicative of one or more of a generic configuration and a specific configuration. A generic configuration can be seen as a static property of the resource and LRS signal and can be provided at any time (such as via PSDCH). In one or more example methods, the generic configuration comprises one or more of a resource pool parameter and an indication indicative of a location reference signal resource allocation structure. The resource pool parameter can be seen as a static property of the resource. In one or more example methods, the resource pool parameter is indicative of one or more of a time relative resource location, a frequency relative resource location, and a size of a sidelink resource pool. The time relative resource location may comprise one or more of time properties, a slot number, a symbol index, such as occupied symbols' indexes, a duration, and a repetition, such as a repetition pattern for semi-persistent SL-LRS transmission. The frequency relative resource location can be seen as a resource set, resource pool, occupied sub-channel location, RB location, RB number. The frequency relative resource location may comprise frequency properties, such as a location and/or size of the dedicated resources for LRS. The frequency properties may for example comprise an offset of the LRS band from legacy sidelink resources or from a reference frequency point, and/or a physical resource block number. The offset may indicate a bandwidth part (BWP) location in the resource pool. The offset may be indicated as an index (ID) of the first resource of the BWP. The size of a sidelink resource pool can be seen as a number of resources within a resource pool (such as resource set).

The location reference signal resource allocation structure can be seen as a LRS-related configuration. The LRS resource allocation structure may be a comb structure, which may be defined as comb type and number of consecutive comb symbols. The indication may indicate the LRS allocation structure in a form such as: {Comb-k, l symbols}, where “Comb-k” indicates the comb type and “l symbols” indicates the number of consecutive comb symbols. A comb structure can be seen as a distribution, such as a distribution pattern, of the occupied subcarriers given a specific occupancy density. The comb structure can in one or more example methods, be described by a comb offset and a comb size. The comb offset may determine the frequency shift of the occupied subcarriers in each symbol. The comb size may refer to the density of the occupied subcarrier in a given reference signal symbol. For example, a comb-2 structure means that LRS occupies every other subcarrier in a given symbol within the allocated bandwidth. The comb structure may be indicated as a combSize and/or combOffset. The comb structure can enable different WDs to transmit LRSs at the same time without interference. In one or more example methods, the generic configuration is indicative of a location reference signal resource allocation structure. The LRS resource allocation structure may be a comb structure, which may be defined as comb type and number of consecutive comb symbols. The density of subcarrier occupied in a given LRS symbol may be referred to as comb size. The indication indicative of the sidelink positioning resource may indicate the LRS allocation structure in a form such as: {Comb-k, l symbols}, where “Comb-k” indicates the comb type and “l symbols” indicates the number of consecutive comb symbols.

The specific configuration can be seen as the parameters that are used at a given time. The given time may be preconfigured and/or signaled. For example, the SL-LRS configuration could be valid for a certain time period (such as LRS transmissions should be repeated during a time window and/or a particular number of times). The specific configuration may be carried by a first stage sidelink control information (SCI-1). The allocated resources may, in one or more example methods, be transmitted to a group of wireless devices (such as the plurality of secondary WDs, such as a configuration for each source WD). For example, the specific configuration can be indicative of whether the resource pool is available or not. The configuration can be groupcast/broadcast to the nearby WDs. This reduces the latency when there are too many WDs that needs to be configured, compared with uni-cast. The specific configuration can be transmitted by the primary WD using second stage sidelink control information (SCI-2). For example, the indication can be indicative of one or more source WD ID and/or one or more destination WD ID. In one or more example methods, the specific configuration is determined based on the positioning resource configuration assistance request.

In one or more example methods, the specific configuration comprises one or more of a preconfiguration parameter, a time offset indicator indicative of a time offset of a sidelink resource pool relative to a reference time, a frequency offset indicator indicative of a frequency offset of a sidelink resource pool relative to a reference frequency, an activation indicator indicating whether the sidelink resource pool is available, a respective first identifier associated with one or more of the plurality of second wireless devices, and the measurement indication indicating the expected positioning measurement-type. The specific configuration can comprise an LRS ID. The LRS ID can be different from a WD ID. A preconfiguration parameter can be seen as a resource allocation which can be pre-configured and can be further triggered by SCI (such as at a physical layer) or MAC (such as at layer 2 and/or the RRC layer) layer signaling from the primary WD or the tertiary WD itself. The particular layer is not limiting, and other layers can be used as well. The source WD may be busy during the configured time slot, and this feature allows the source WD to postpone the LRS transmission and reactivate the pre-configured resource when it becomes available. In one or more example methods, the preconfiguration parameter is an indication of a preconfiguration parameter, such as conveying an index representing a chosen set of preconfiguration parameters. The activation indicator can be, for example, an on and/or off indication. The respective first identifier can be a WD ID(s) of the LRS source WD and/or the LRS destination WD. The respective first identifier can be an implicit indication. The respective first identifier can be indicative of a location reference signal source WD and/or location reference signal destination WD. The measurement indication can be indicative of the expected measurements by the WDs performing LRS measurements. From the LRS reception, the WD can perform timing measurement (such as RTT, and/or TDOA), angle measurement, and/or power measurement. In one or more example methods, the plurality of secondary WDs may transmit LRS to be measured by a tertiary WD. In one or more example methods, the plurality of secondary WDs may be configured to receive LRS from the tertiary WD, and perform measurements.

In one or more examples methods, the generic configuration and specific configuration are conveyed in different transmission layers. A transmission layer may be seen as a protocol layer. For example, a generic configuration can be conveyed in PSSCH. For example, a generic configuration can be in a form of a PC5 RRC message. A specific configuration can be conveyed using PSCCH. Other layers can be used as well.

In one or more example methods, the plurality of secondary wireless devices includes at least two location reference signal transmitting wireless devices, such as LRS source WDs, or at least two location reference signal receiving wireless devices, such as LRS destination WDs. The particular number of location reference signal transmitting wireless devices and/or location reference signal receiving wireless devices is not limiting.

In one or more example methods, the tertiary wireless device is a sidelink positioning initiating wireless device.

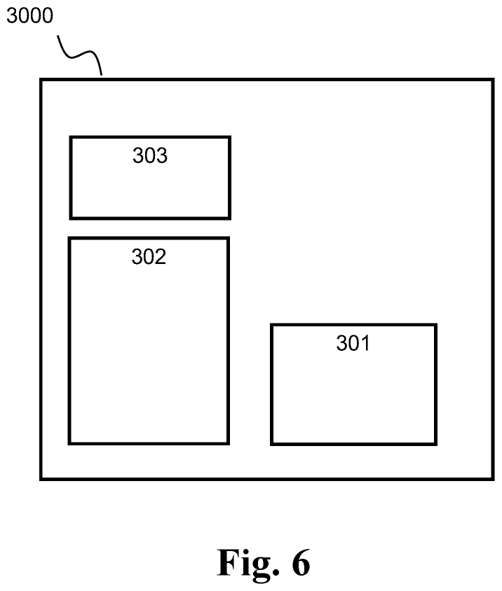

FIG. 6 shows a block diagram of an example primary wireless device 3000 according to the disclosure. The primary wireless device 3000 comprises memory circuitry 301, processor circuitry 302, and a wireless interface 303. In other words, the primary wireless device 3000 may be configured for sidelink positioning coordination.

The primary wireless device 3000 can be configured to communicate with one or more secondary wireless devices, such as the plurality of second wireless devices 300B, 300C and third wireless device 300D of FIG. 1, via sidelink.

In one or more example primary wireless devices, the primary wireless device 3000 is configured to determine (such as using the processor circuitry 302) a LRS configuration for sidelink positioning to be used by a plurality of second wireless devices. In one or more example first wireless devices, the primary wireless device 3000 is configured to transmit (such as using the processor circuitry 302 and/or the wireless interface 303), to the plurality of secondary wireless devices, an indication indicative of the location reference signal configuration.

In one or more example primary wireless devices, the primary wireless device 3000 is configured to determine the location reference signal configuration by sensing (such as using the processor circuitry 302 and/or the wireless interface 303) on a sidelink resource pool.

In one or more example primary wireless devices, the primary wireless device 3000 is configured to determine the location reference signal configuration by determining (such as using the processor circuitry 302) the location reference signal configuration for sidelink positioning based on the sensing.

In one or more example primary wireless devices, the primary wireless device 3000 is configured to determine the location reference signal configuration by allocating (such as using the processor circuitry 302 and/or the memory circuitry 303) respective location reference signal resources for a plurality of location reference signal transmitting wireless devices of the plurality of secondary wireless devices.

In one or more example primary wireless devices, the primary wireless device 3000 is configured to allocate the respective location reference signal resources by allocating (such as using the processor circuitry 302 and/or the memory circuitry 303) respective location reference signal resources in a first time slot.

In one or more example primary wireless devices, the primary wireless device 3000 is configured to allocate the respective location reference signal resources by allocating (such as using the processor circuitry 302 and/or the memory circuitry 303) respective location reference signal resources in a first symbol.

In one or more example primary wireless devices, the primary wireless device 3000 is configured to allocate the respective location reference signal resources by allocating (such as using the processor circuitry 302 and/or the memory circuitry 303) respective location reference signal resources in adjacent symbols.

In one or more example primary wireless devices, the primary wireless device 3000 is configured to receive (such as using the processor circuitry 302 and/or using the interface 303), from a tertiary wireless device, a positioning resource configuration assistance request.

In one or more example primary wireless devices, the first wireless device is a resource scheduling wireless device.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution, LTE, LTE-enhanced Machine Type Communication, LTE-M, millimeter-wave communications, operating frequency in licensed bands, and in unlicensed bands.

The primary wireless device 3000 is optionally configured to perform any of the operations (such as methods) disclosed in FIG. 5 (such as any one or more of S101, S103, S103A, S103B, S103C, S103CA, S103CB, S103CC, S105). The operations of the primary wireless device 3000 may be embodied in the form of executable logic routines (for example, lines of code, software programs, etc.) that are stored on a non-transitory computer readable medium (for example, memory circuitry 301) and are executed by processor circuitry 302.

Furthermore, the operations of the primary wireless device 3000 may be considered a method that the primary wireless device 3000 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 6). Memory circuitry 301 is considered a non-transitory computer readable medium.

Memory circuitry 301 may be configured to store information, such as a location reference signal configuration, a positioning resource configuration assistance request, such as an indication indicative of location reference signal configuration, in a part of the memory.

Examples of the method and the primary wireless device according to the disclosure are set out in the following items:

Item 1. A method, performed by a primary wireless device, the method comprising:
determining (S103) a location reference signal configuration for sidelink positioning to be used by a plurality of secondary wireless devices, and
transmitting (S105), to the plurality of secondary wireless devices, an indication indicative of the location reference signal configuration.

Item 2. The method according to item 1, wherein determining (S103) comprises sensing (S103A) on a sidelink resource pool.

Item 3. The method according to item 2, wherein determining (S103) comprises determining (S103B) the location reference signal configuration for sidelink positioning based on the sensing.

Item 4. The method according to any one of the previous items, wherein determining (S103) comprises allocating (S103C) respective location reference signal resources for a plurality of location reference signal transmitting wireless devices of the plurality of secondary wireless devices.

Item 5. The method according to item 4, wherein allocating (S103C) the respective location reference signal resources, comprises allocating (S103CA) respective location reference signal resources in a first time slot.

Item 6. The method according to item 4 or 5, wherein allocating (S103C) the respective location reference signal resources, comprises allocating (S103CB) respective location reference signal resources in a first symbol.

Item 7. The method according to item 4 or 5, wherein allocating (S103C) the respective location reference signal resources, comprises allocating (S103CC) respective location reference signal resources in adjacent symbols.

Item 8. The method according to any of items 4 to 7, wherein the respective location reference signal resources for the plurality of location reference signal transmitting wireless devices have different resource element offsets.

Item 9. The method according to any one of the previous items, wherein the method comprises:
receiving (S101), from a tertiary wireless device, a positioning resource configuration assistance request.

Item 10. The method according to item 9, wherein the positioning resource configuration assistance request comprises one or more of:
a first assistance indication indicating that the positioning resource configuration assistance request is for location reference signal transmission,
a respective first identifier associated with one or more of the plurality of second wireless devices,
a second assistance indication indicating a number of second wireless devices, and
a measurement indication indicating the expected positioning measurement-type.

Item 11. The method according to any one of the previous items, wherein the indication is indicative of one or more of a generic configuration and a specific configuration.

Item 12. The method according to item 11, wherein the generic configuration and specific configuration are conveyed in a different transmission layer.

Item 13. The method according to item 11 or 12 when dependent on any one of items 9 to 10, wherein the specific configuration is determined based on the positioning resource configuration assistance request.

Item 14. The method according to any one of items 11 to 13, wherein the generic configuration comprises one or more of a resource pool parameter and an indication indicative of a location reference signal resource allocation structure.

Item 15. The method according to item 14, wherein the resource pool parameter is indicative of one or more of:
a time relative resource location,
a frequency relative resource location, and
a size of a sidelink resource pool.

Item 16. The method according to any one of the items 11 to 15, wherein the specific configuration comprises one or more of:
a preconfiguration parameter,
a time offset indicator indicative of a time offset of a sidelink resource pool relative to a reference time,
a frequency offset indicator indicative of a frequency offset of a sidelink resource pool relative to a reference frequency,
an activation indicator indicating whether the sidelink resource pool is available,
a respective first identifier associated with one or more of the plurality of second wireless devices, and
a measurement indication indicating the expected positioning measurement-type.

Item 17. The method according to any one of the previous items, wherein the primary wireless device is a resource scheduling wireless device.

Item 18. The method according to any one of the previous items, wherein the plurality of secondary wireless devices comprises at least two location reference signal transmitting wireless device or at least two location reference signal receiving wireless device.

Item 19. The method according to item 9, wherein the tertiary wireless device is a sidelink positioning initiating wireless device.

Item 20. A primary wireless device comprising memory circuitry, processor circuitry, and a wireless interface, wherein the primary wireless device is configured to perform any of the methods according to any of items 1-19.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that the figures comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented.

Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (such as none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a primary wireless device, the method comprising:
determining a location reference signal configuration for sidelink positioning to be used by a plurality of secondary wireless devices, and
transmitting to the plurality of secondary wireless devices, an indication indicative of the location reference signal configuration.

2. The method according to claim 1, wherein determining comprises sensing on a sidelink resource pool.

3. The method according to claim 2, wherein determining comprises determining the location reference signal configuration for sidelink positioning based on the sensing.

4. The method according to claim 1, wherein determining comprises allocating respective location reference signal resources for a plurality of location reference signal transmitting wireless devices of the plurality of secondary wireless devices.

5. The method according to claim 4, wherein allocating the respective location reference signal resources, comprises allocating respective location reference signal resources in a first time slot.

6. The method according to claim 4, wherein allocating the respective location reference signal resources, comprises allocating respective location reference signal resources in a first symbol.

7. The method according to claim 4, wherein allocating the respective location reference signal resources, comprises allocating respective location reference signal resources in adjacent symbols.

8. The method according to claim 4, wherein the respective location reference signal resources for the plurality of location reference signal transmitting wireless devices have different resource element offsets.

9. The method according to claim 1, wherein the method comprises:
receiving from a tertiary wireless device, a positioning resource configuration assistance request.

10. The method according to claim 9, wherein the positioning resource configuration assistance request comprises one or more of:
a first assistance indication indicating that the positioning resource configuration assistance request is for location reference signal transmission,
a respective first identifier associated with one or more of the plurality of second wireless devices,
a second assistance indication indicating a number of second wireless devices, and
a measurement indication indicating the expected positioning measurement-type.

11. The method according to claim 1, wherein the indication is indicative of one or more of a generic configuration and a specific configuration.

12. The method according to claim 11, wherein the generic configuration and specific configuration are conveyed in a different transmission layer.

13. The method according to claim 11 wherein the specific configuration is determined based on the positioning resource configuration assistance request.

14. The method according to claim 11, wherein the generic configuration comprises one or more of a resource pool parameter and an indication indicative of a location reference signal resource allocation structure.

15. The method according to claim 14, wherein the resource pool parameter is indicative of one or more of:
a time relative resource location,
a frequency relative resource location, and
a size of a sidelink resource pool.

16. The method according to claim 11, wherein the specific configuration comprises one or more of:
a preconfiguration parameter,
a time offset indicator indicative of a time offset of a sidelink resource pool relative to a reference time,
a frequency offset indicator indicative of a frequency offset of a sidelink resource pool relative to a reference frequency,
an activation indicator indicating whether the sidelink resource pool is available,
a respective first identifier associated with one or more of the plurality of second wireless devices, and
a measurement indication indicating the expected positioning measurement-type.

17. The method according to claim 1, wherein the primary wireless device is a resource scheduling wireless device.

18. The method according to claim 1, wherein the plurality of secondary wireless devices comprises at least two location reference signal transmitting wireless device or at least two location reference signal receiving wireless device.

19. The method according to claim 9, wherein the tertiary wireless device is a sidelink positioning initiating wireless device.

20. A primary wireless device comprising memory circuitry, processor circuitry, and a wireless interface, wherein the primary wireless device is configured to perform the method according to claim 1.
